(19) United States
(12) Patent Application Publication
(10) Pub. No.: US 2008/0264722 A1
(43) Pub. Date: Oct. 30, 2008

(54) Stair Climbing Aid

(76) Inventors: Jiin-Hwa YANG, Nantou County (TW); Hui-Li Weng, Nantou County (TW)

Correspondence Address: Dr. BANGER SHIA, 102 Lindencrest Ct., Sugar Land, TX, 77479-5201, US

(21) Appl. No.: 12/108,690

(22) Filed: Apr. 24, 2008

(30) Foreign Application Priority Data
Apr. 27, 2007 (TW) 096115083
Apr. 30, 2007 (TW) 096206914

(51) Int. Cl. E06C 5/00; E06C 7/00; E06C 9/00

(52) U.S. Cl. 182/15; 135/66; 182/106; 182/19

(57) ABSTRACT

A stair climbing aid comprises two slide rails, an assist member, a control mechanism and two positioning assemblies. The slide rails and the assist member are assembled to handrails at both sides of the stairs. The control mechanism is disposed on the assist member to be controlled by the user. The positioning assemblies are disposed at both sides of the assist member, each positioning assembly is provided with an engaging portion to be engaged in the respective positioning portions of the slide rail. Thereby, an anti-slide effect is produced, so as to prevent the user from falling down the stairs and to help the user move from step to step safely.

### BACKGROUND OF THE INVENTION

1. Field of the Invention

The present invention relates to a stair climbing aid, and more particularly to a stair climbing aid which assists physically impaired people in climbing up and down stairs independently and easily.

2. Description of the Prior Art

Climbing stairs is an easy thing for a healthy person, but it is a big problem for a physically impaired or an aged person. This problem is becoming even worse since today the number of the aged people is increasing and the buildings are also becoming more and more high. Although elevator or escalator can be used to facilitate access to different floors, not every building is suitable to have an elevator or escalator. In addition, elevator or escalator not only is expensive but also requires a large installation space, not any family can afford it. Therefore, many physically impaired or aged people have to move sideways by grasping one handrail with one hand or move up slowly by grasping two handrails with both hands and slide their hands, and there is no support or protection device in front of the climber. The climber's safety solely relies on his arm strength, the accident of falling off the stairs often occurs.

The present invention has arisen to mitigate and/or obviate the afore-described disadvantages.

### SUMMARY OF THE INVENTION

The present invention is to provide a stair climbing aid which assists physically impaired people, such as a patient and an aged person, in climbing up and down stairs, and is affordable for any family since it is inexpensive and occupies a small installation space.

Requiring only a small or even no electric power, the stair climbing aid allows the user to climb up and down stairs safely with his arm strength.

To achieve the above objective, the present invention provides a stair climbing aid which is an assist member capable of sliding along two handrails of the stairs and comprises:

two slide rails assembled to both sides of the stairs, each slide rail is defined with a slide groove in an inner side thereof and is provided with a plurality of positioning portions, the slide grooves are opposite to each other;

an assist member, both ends of the assist member are slidably received in the slide grooves of the slide rails;

a control mechanism disposed on the assist member to be controlled by the user; and

two positioning assemblies, each positioning assembly is provided with a spring, a connecting portion and an engaging portion, the spring is biased between the connecting portion and the engaging portion, the engaging portion is pushed by the spring to protrude out of one side of the assist member and is connected to the control mechanism by a connecting member.

Therefore, the stair climbing aid of the present invention can assist the user in climbing up and down stairs and has an anti-slide effect, so as to prevent the user from falling down the stairs and to help the user move from step to step safely.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a stair climbing aid in accordance with a first embodiment of the present invention;

FIG. 2 is a perspective view of an assist member and a control mechanism in accordance with the first embodiment of the present invention;

FIG. 3 is an illustrative view showing a state of climbing up stairs in accordance with the first embodiment of the present invention;

FIG. 4 is a plan view showing the state of climbing up the stairs in accordance with the first embodiment of the present invention;

FIG. 5 is an illustrative view showing a state of climbing down the stairs in accordance with the first embodiment of the present invention;

FIG. 6 is a plan view showing the state of climbing down the stairs in accordance with the first embodiment of the present invention;

FIG. 7 is a plan view showing engaging portions move into positioning assemblies when climbing down the stairs;

FIG. 8 is a plan view showing the state of climbing down the stairs in accordance with the first embodiment of the present invention;

FIG. 9 is a perspective view of a stair climbing aid in accordance with a second embodiment of the present invention;

FIG. 10 is a perspective view of the assist member and the control mechanism in accordance with the second embodiment of the present invention;

FIG. 11 is an assembly perspective view of the assist member and the control mechanism in accordance with the second embodiment of the present invention;

FIG. 12 is a plan view showing the engaging portions move into the positioning assemblies when climbing down the stairs;

FIG. 13 is a plan view showing couple shafts being pushed by springs when climbing down the stairs; and

FIG. 14 is a plan view showing linking assemblies being pushed by elastic members to protrude out of blocking pieces again in accordance with the second embodiment of the present invention.

### DETAILED DESCRIPTION OF THE PREFERRED EMBODIMENTS

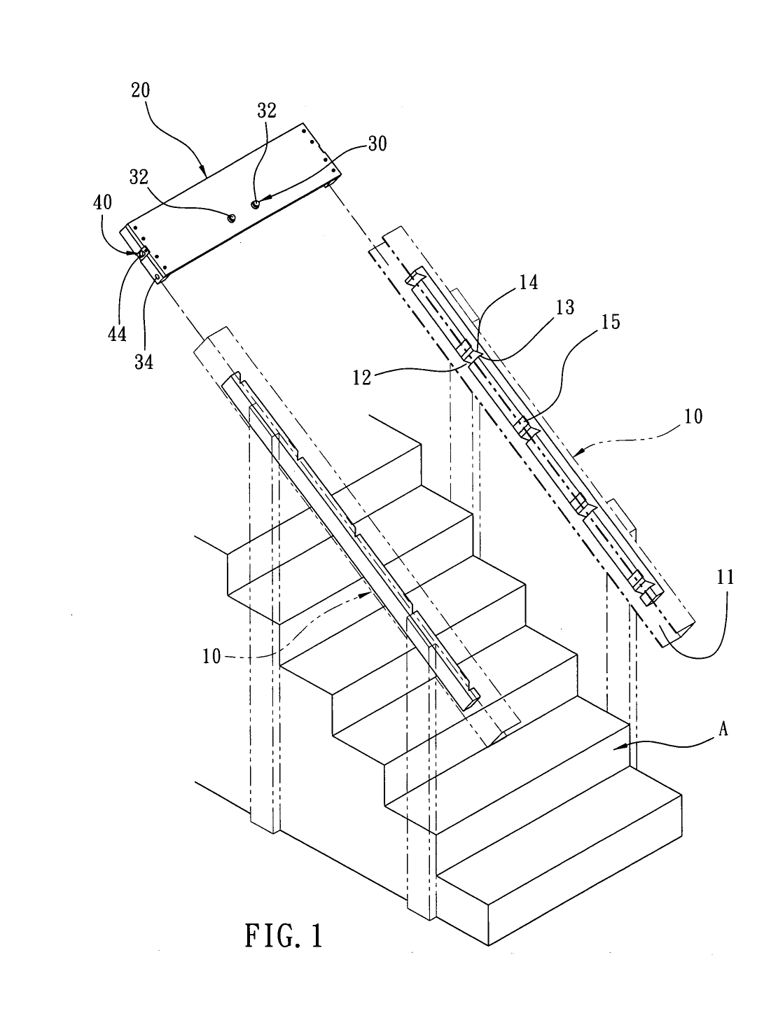

Referring to FIG. 1, a stair climbing aid in accordance with the present invention is assembled to stairs A and comprises two slide rails 10, an assist member 20, a control mechanism 30 and two positioning assemblies 40.

The slide rails 10 are assembled to both sides of the stairs A at an inclined angle (in this embodiment, they are assembled to the handrails at both sides of the stairs A by nails, bolts, screws, adhesive agent and so on). Each slide rail 10 is defined with a slide groove 11 in an inner side thereof and is provided with a plurality of positioning portions 12 in the form of an undercut (the positioning portion 12 can also be a groove, a hole or a cavity), and the slide grooves 11 are opposite to each other. Each positioning portion 12 is ∠-shaped, and is formed with a bottom surface 13 and a top surface 14. The bottom surface 13 is vertical to the extension direction of the slide rail 10. A induction member 15 is fixed adjacent to each positioning portion 12 by nails, bolts, screws, adhesive agent and so on, and the induction members 15 are disposed in the same direction.

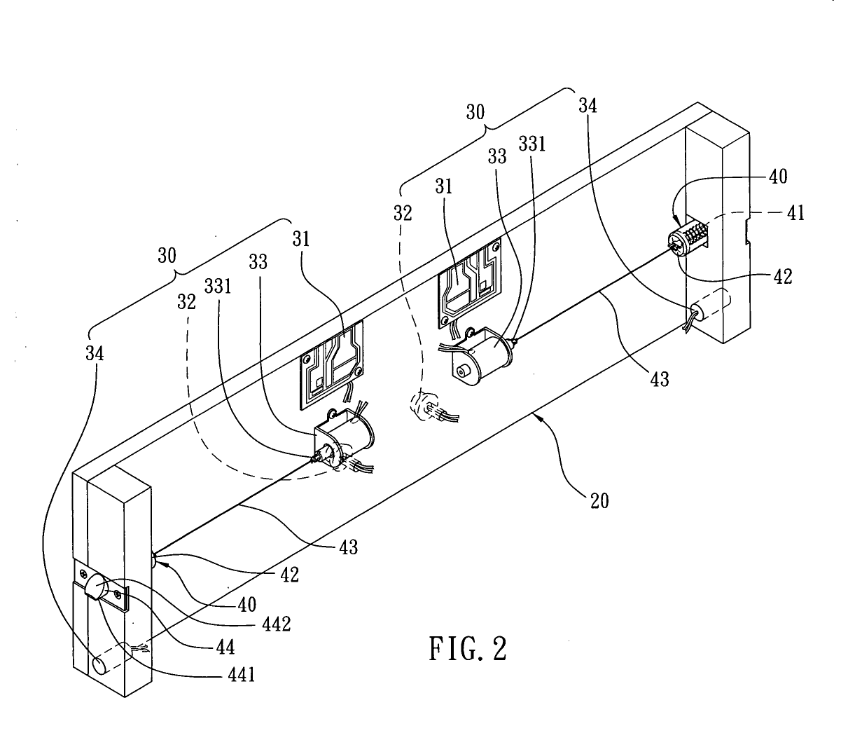

Referring to FIGS. 1 and 2, both ends of the assist member 20 are slidably received in the slide grooves 11 of the slide rails 10.

Referring to FIG. 2, the control mechanism 30 is disposed on the assist member 20 and comprises two control circuits 31, two buttons 32, two electromagnets 33 and two sensors 34, all the members of the control mechanism 30 are symmetrically disposed (and can be inlayed in or assembled to the assist member 20 by nails, bolts, screws, adhesive agent and so on). The buttons 32 are connected to their corresponding control circuits 31 and electromagnets 33. One of the electromagnets 33 is inserted with a driving rod 331 that is protruded out of one side of the electromagnet 33. After being electrified, the electromagnet 33 will drive the driving rod 331 to make one end of the driving rod 331 extend out of the electromagnet 33, and the sensors 34 cooperate with the induction members 15 that are used to sense the slide rails 10 to carry out sensing operation (the sensing mode can be metal sensing, RFID sensing, magnetic sensing, infrared sensing and so on). The control circuits 31 are connected to a power source and each is electrically connected to its corresponding button 32, electromagnet 33 and sensor 34 (in this embodiment, the control circuit 31, the button 32, the electromagnet 33 and the sensor 34 are connected by a wire or are wirelessly connected). The electromagnets 33 are connected to their corresponding positioning assemblies 40 by the driving rods 331.

Referring to FIG. 2 again, each positioning assembly 40 is provided with a spring 41, a connecting portion 42 and an engaging portion 44. The spring 41 is biased between the connecting portion 42 and the engaging portion 44. The engaging portion 44 is pushed by the spring 41 to protrude out of one side of the assist member 20 and is connected to the driving rod 331 of the control mechanism 30 by a connecting member 43 (in this embodiment, the connecting member 43 is a rope and can also be a string, a line, a thread, a chain, or a cable as long as it is strong enough to bear the driving force). The engaging portion 44 is ∠-shaped, and comprises an engaging surface 441 and a sliding surface 442. The engaging portion 44 cooperates with the positioning portion 12 to perform a telescopic movement.

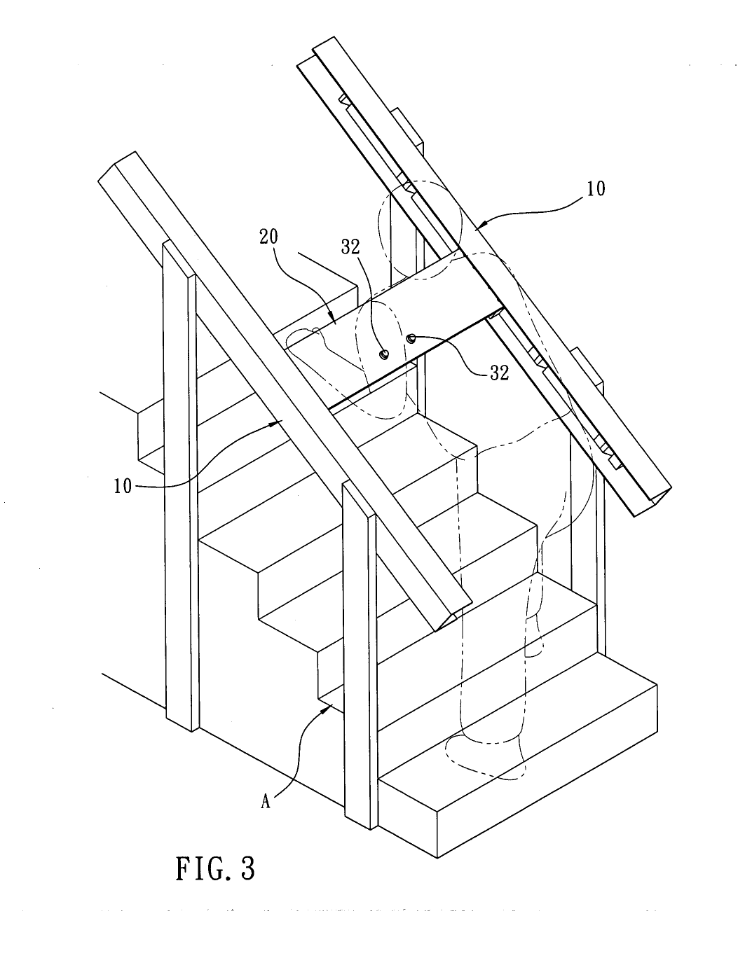

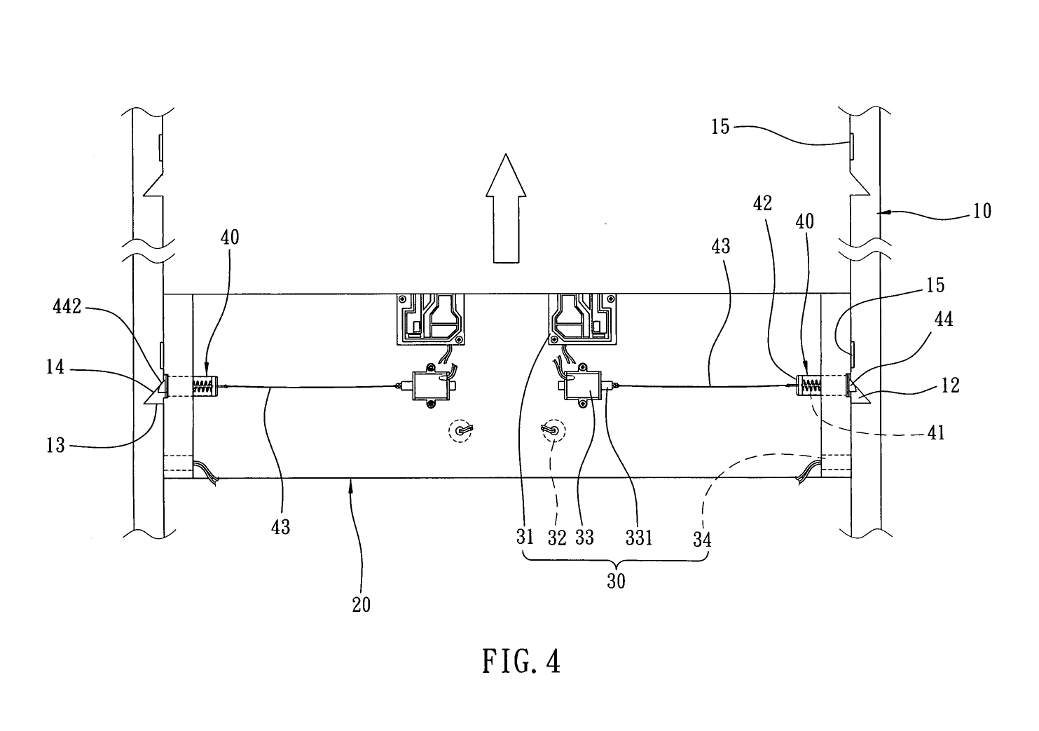

Referring to FIG. 3, when climbing up the stairs A, the upper body of the user bends over the assist member 20, the assist member 20 is engaged in the positioning portions 12 of the slide rails 10 by the engaging surfaces 441 of the engaging portions 44 of the positioning assemblies 40, so as to prevent the assist member 20 from sliding out of the slide rails 10. When the user pushes the assist member 20 and moves upwardly as shown in FIG. 4, the top surfaces 14 of the positioning portions 12 will push the sliding surfaces 442 of the engaging portions 44 to move into the positioning assemblies 40 and cause compression of the springs 41, which allows the assist member 20 to slide in the slide rails 10 freely, such that the user can push the assist member 20 easily and move upwardly.

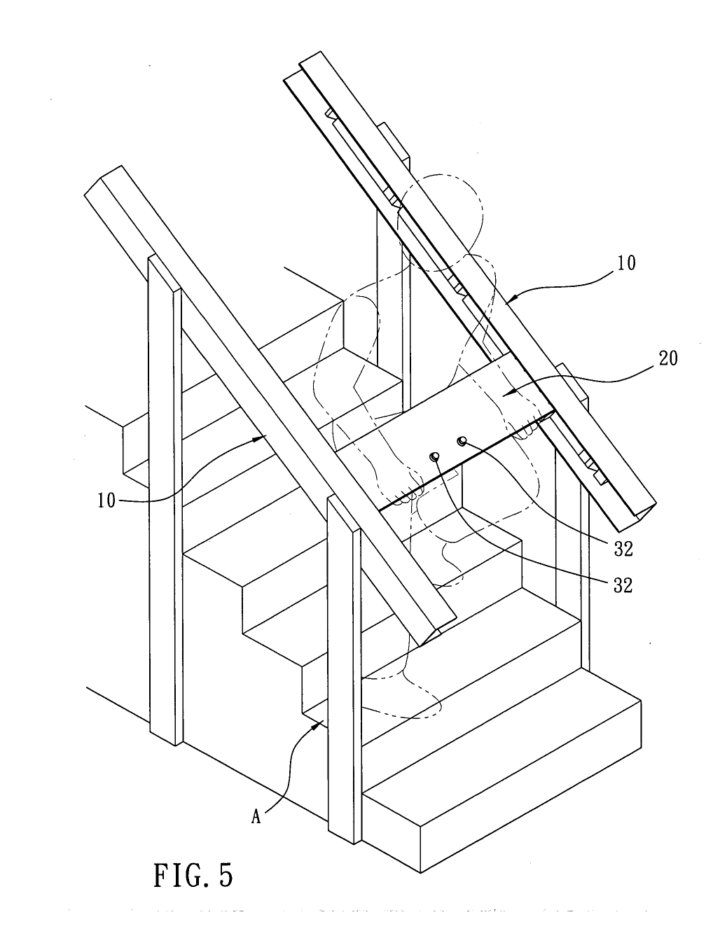

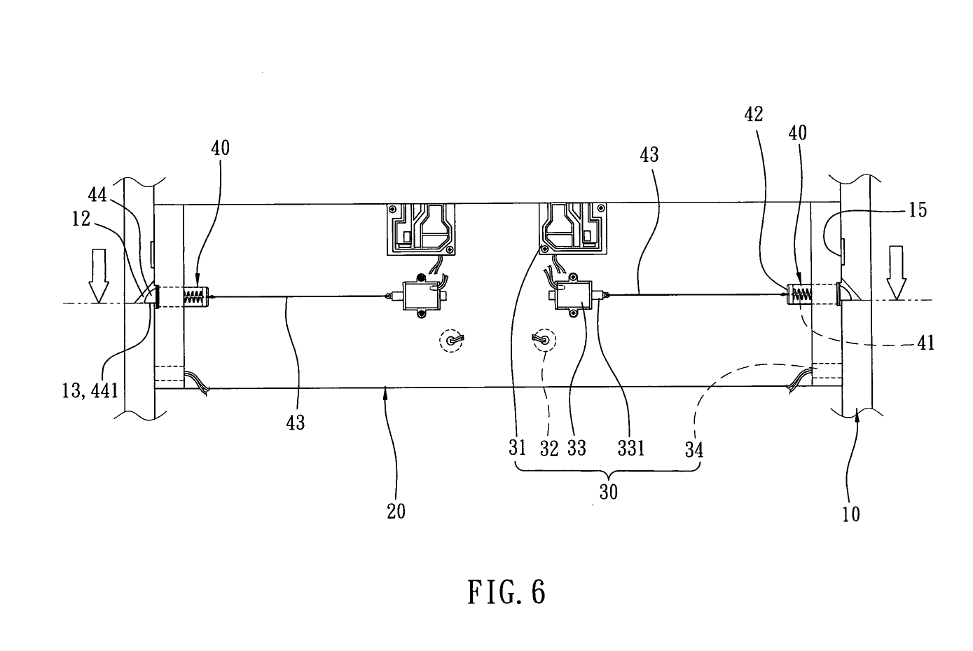

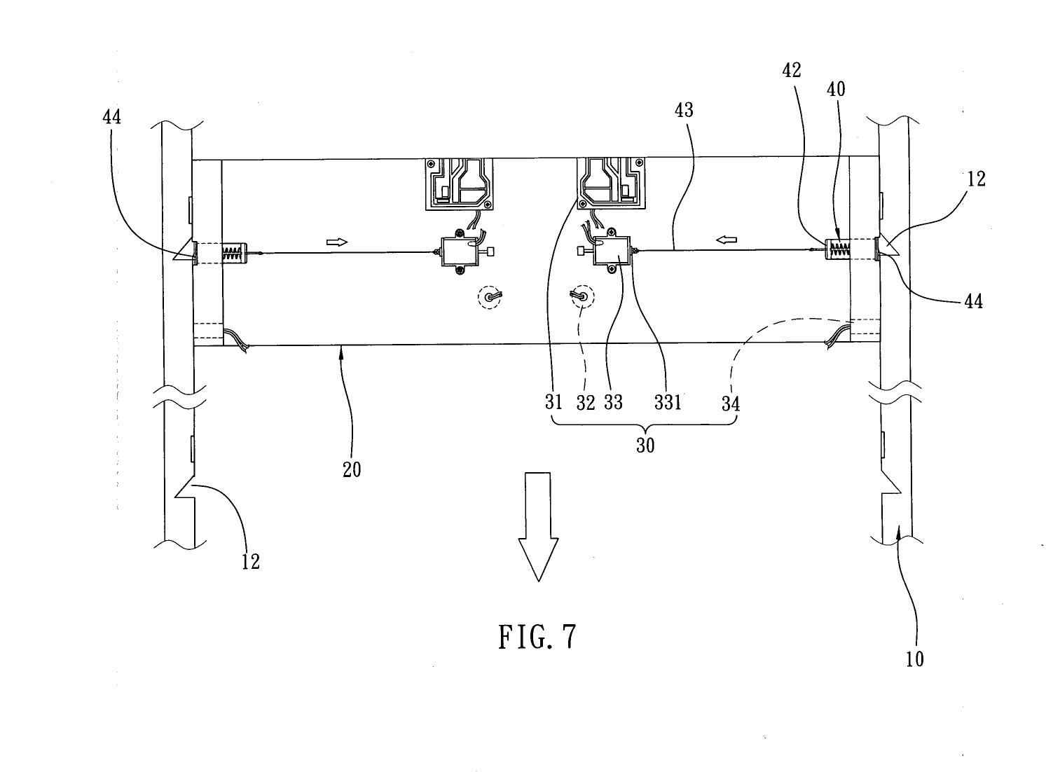

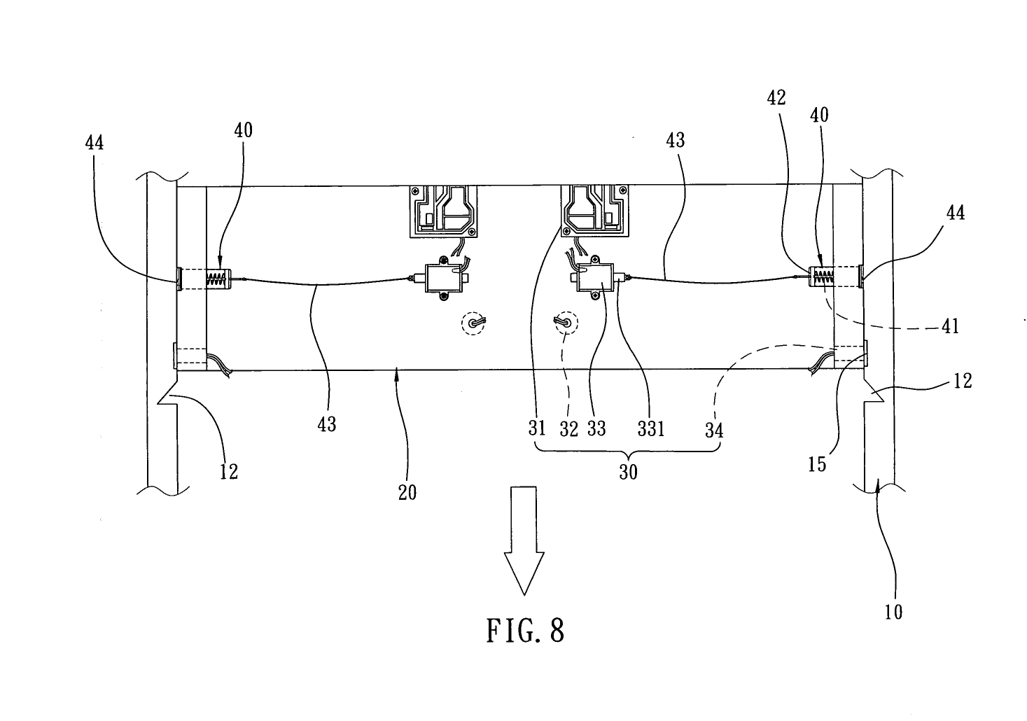

Referring to FIG. 5, when climbing down the stairs A, the user presses the buttons 32 of the control mechanism 30 disposed on the assist member 20, the buttons 32 will instruct the control circuits 31 electrify the electromagnets 33 to move the driving rods 331 into the electromagnets 33 as shown in FIG. 6, so as to pull the connecting members 43 and the connecting portions 42, thus driving the engaging portions 44 to move into the positioning assemblies 40 and cause compression of the springs 41. Thereby, the positioning assemblies 40 disposed at both sides of the assist member 20 will be disengaged from the positioning portions 12 to allow the assist member 20 to slide in the slide rails 10, thus allowing the user to push the assist member 20 and move downwardly as shown in FIG. 7. When the assist member 20 is pushed to slide in the slide rails 10, and the sensors 34 sense the induction members 15 as shown in FIG. 8, the sensors 34 will instruct the control circuits 31 stop supplying current to the electromagnets 33, so as to make the driving rods 331 extend out of the electromagnets 33 again to release the engaging portions 44 of the positioning assemblies 40, such that the engaging portions 44 will be pushed by the springs 41 to protrude out of the positioning assemblies 40. When the assist member 20 moves to the position where the engaging portions 44 are engaged with the positioning portions 12 as shown in FIG. 8, the engaging surfaces 441 of the engaging portions 44 will be engaged in the positioning portions 12 and positioned on the bottom surfaces 13, such that the assist member 20 can be positioned between the slide rails 10, thus allowing the user to lean on the assist member 20 to prevent the user from falling down the stairs A. Then, by pressing the control mechanism 30 again, the user can move a further distance.

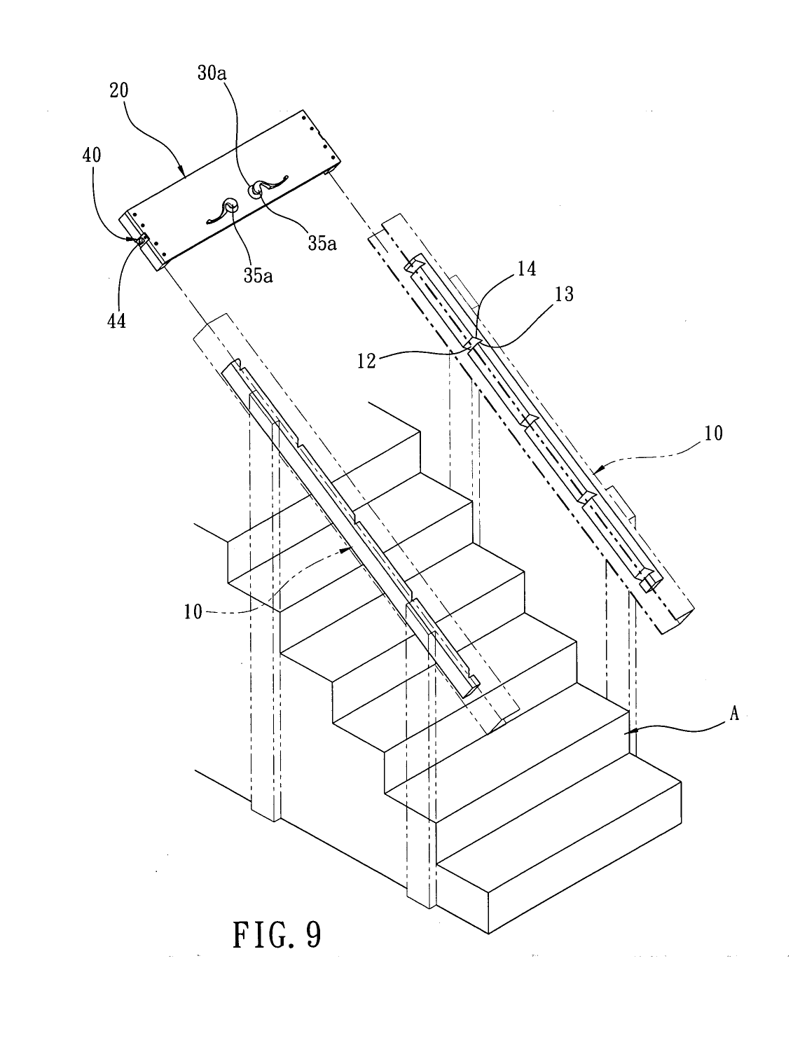

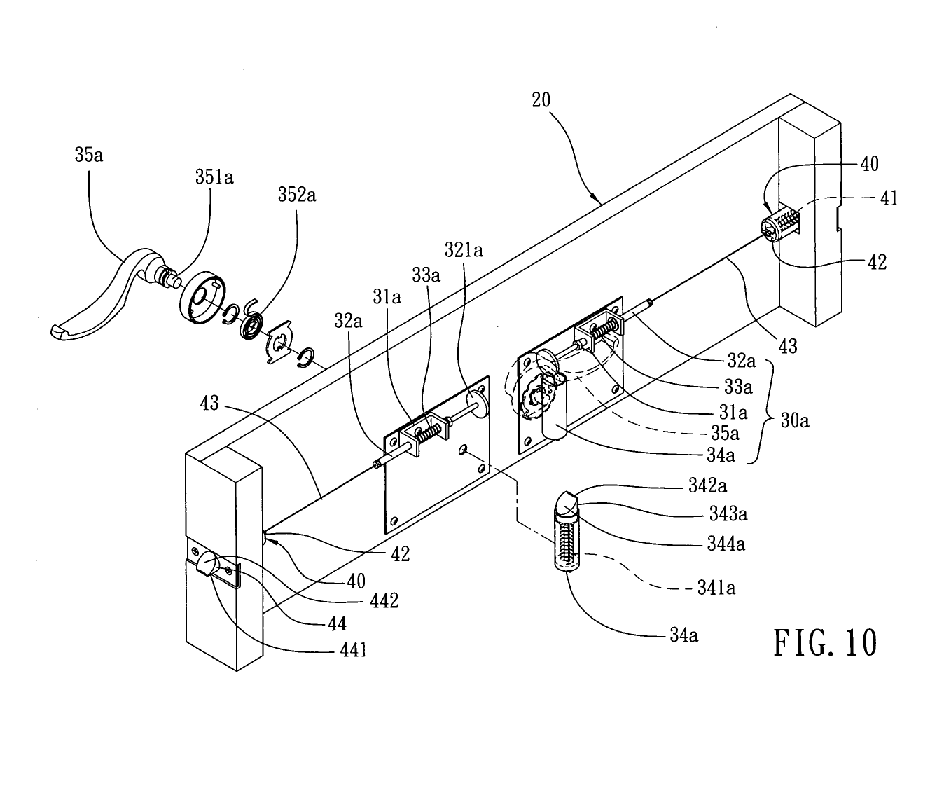

In addition to the electrical control design of the control mechanism 30 as shown in FIGS. 1-8, the control mechanism 30 can also be controlled by a non-electrical means as shown in FIGS. 9-14. Referring to FIGS. 9 and 10, a control mechanism 30a is disposed on the assist member 20 and comprises two positioning seats 31a, two couple shafts 32a, two springs 33a, two linking assemblies 34a and two control handles 35a, and all the members of the control mechanism 30a are symmetrically disposed. The positioning seat 31a is U-shaped and is provided with its corresponding couple shaft 32a and spring 33a. The couple shaft 32a is inserted into the positioning seat 31a, and the spring 33a is mounted on the couple shaft 32a. Such arrangements allow the couple shaft 32a to move in one direction only, and the couple shaft 32a will be repositioned by the spring 33a. One end of the couple shaft 32a is provided with a blocking piece 321a, and the other end of the couple shaft 32a is connected to the connecting member 43 to control the engaging portion 44. An elastic member 341a is disposed in the linking assembly 34a, and an end of the elastic member 341a is provided with a locking tongue 342a having a pushing surface 343a and a sliding surface 344a. The control handle 35a is fixed on one side of the assist member 20 by a connecting shaft 351a and located at a position adjacent to its corresponding couple shaft 32a, an elastic piece 352a is mounted on the connecting shaft 351a, and the connecting shaft 351a is inserted into the other side of the assist member 20 to connect to the linking assembly 34a. The control handle 35a controls the rotation of its corresponding linking assembly 34a, and the locking tongue 342a of the linking assembly 34a is located corresponding to the blocking piece 321a.

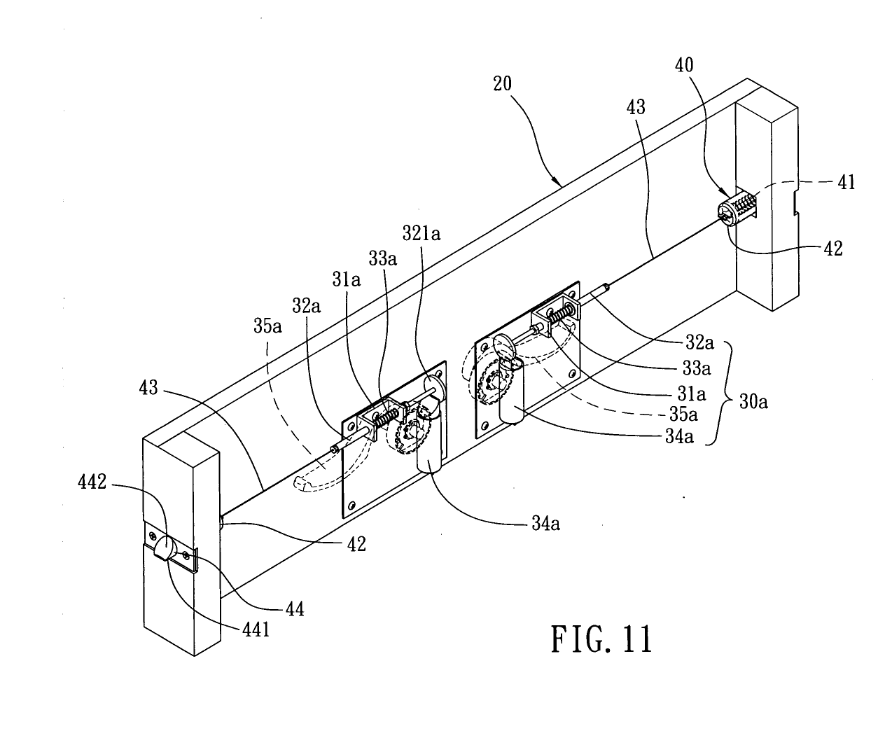

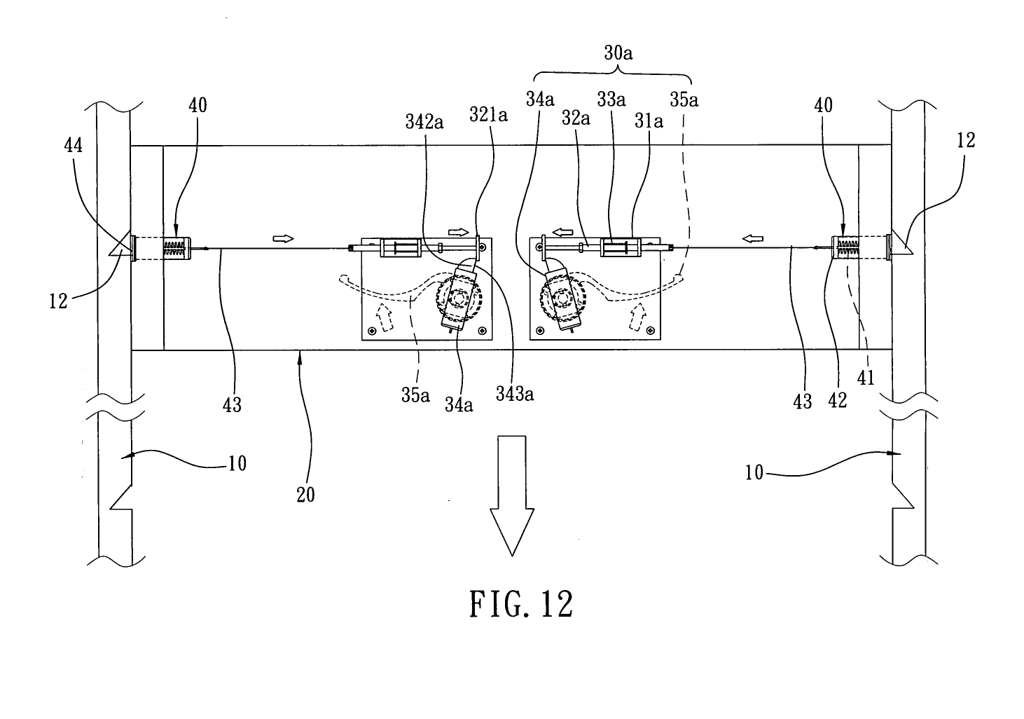

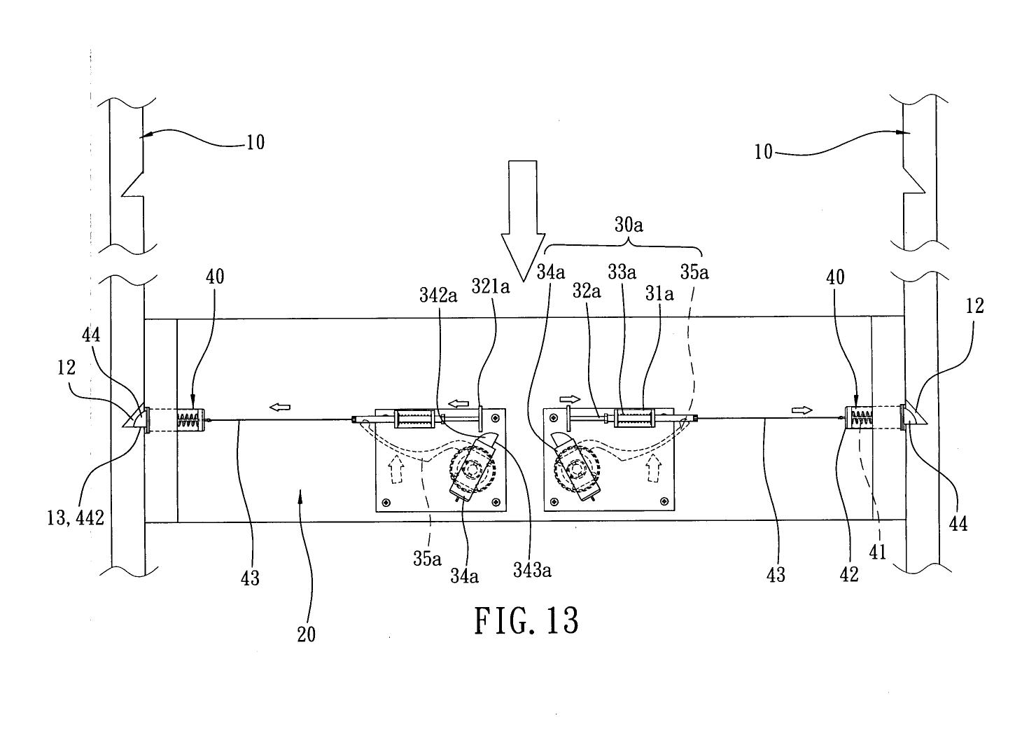

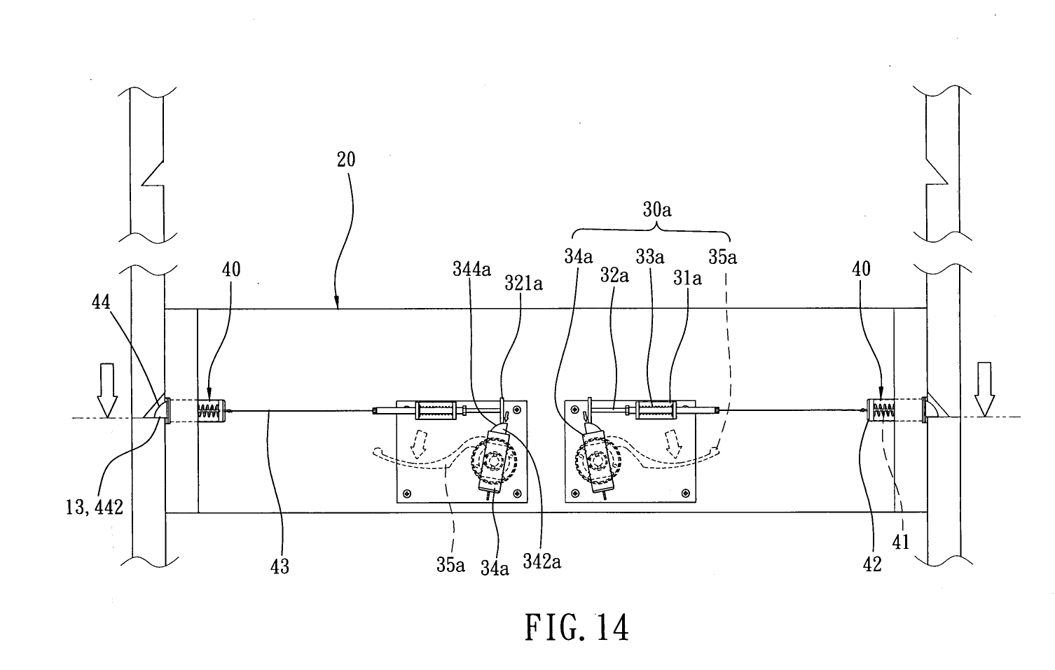

Referring to FIGS. 11 and 12, when climbing down the stairs A, the user rotates the control handles 35a disposed on the assist member 20, the control handles 35a will drive the linking assemblies 34a to rotate, and then the linking assemblies 34a use the pushing surfaces 343a of the locking tongues 342a to push the blocking pieces 321a, so as to pull the couple shafts 32a and cause compression of the springs 33a. Simultaneously, the couple shafts 32a will pull the connecting members 43 and the connecting portions 42, thus driving the engaging portions 44 to move into the positioning assemblies 40 and cause compression of the springs 41. Thereby, the positioning assemblies 40 disposed at both sides of the assist member 20 will be disengaged from the positioning portions 12 to allow the assist member 20 to slide in the slide rails 10, thus allowing the user to push the assist member 20 and move downwardly. When the control handles 35a are rotated exceeding a predetermined radian, the locking tongues 342a will not contact the blocking pieces 321a, and the couple shafts 32a will be pushed by the springs 33a as shown in FIG. 13. Thereby, the engaging portions 44 will be pushed by the springs 41 to protrude out of the positioning assemblies 40. When the assist member 20 moves to the position where the engaging portions 44 are engaged with the positioning portions 12, the engaging surfaces 441 of the engaging portions 44 will be engaged in the positioning portions 12 and positioned on the bottom surfaces 13, such that the assist member 20 can be positioned between the slide rails 10, thus allowing the user to lean on the assist member 20 to prevent the user from falling down the stairs A. After each time the user rotates the control handles 35a and releases it, the elastic pieces 352a will push the control handles 35a to rotate back to their original positions. When the locking tongues 342a pass through the blocking pieces 321a, the sliding surfaces 344a of the locking tongues 342a will be blocked and pushed by the blocking pieces 321a to move the locking tongues 342a into the blocking pieces 321a, so as to make the control handles 35a rotate back to their original positions. In addition, the locking tongues 342a will be pushed by the elastic members 341a to protrude out of the blocking pieces 321a again, and the engaging portions 44 will also be pushed by the springs 41 to protrude out of the positioning assemblies 40 as shown in FIG. 14.

With the above-mentioned structures, the stair climbing aid of the present invention can assist the user in climbing up and down stairs. The assist member 20 is engaged in the stairs A, so an anti-slide effect is produced, so as to prevent the user from falling down the stairs A and to help the user move from step to step safely.

While we have shown and described various embodiments in accordance with the present invention, it should be clear to those skilled in the art that further embodiments may be made without departing from the scope of the present invention.

What is claimed is:

1. A stair climbing aid being assembled to stairs, comprising:
two slide rails assembled to both sides of the stairs, each slide rail being defined with a slide groove and provided with a plurality of positioning portions;
an assist member, both ends of which being slidably received in the slide grooves of the slide rails;
a control mechanism disposed on the assist member; and
two positioning assemblies connected to the control mechanism and disposed at both sides of the assist member, each positioning assembly being provided with a spring, a connecting portion and an engaging portion, the spring being biased between the connecting portion and the engaging portion, the engaging portion being pushed by the spring to protrude out of one side of the assist member and connected to the control mechanism by a connecting member, the engaging portions of the positioning assemblies cooperating with the positioning portions of the slide rails.

2. The stair climbing aid as claimed in claim 1, wherein the slide grooves are defined in inner sides of the slide rails and are opposite to each other.

3. The stair climbing aid as claimed in claim 1, wherein each positioning portion of the slide rail is ∠-shaped, and is formed with a bottom surface and a top surface.

4. The stair climbing aid as claimed in claim 1, wherein the engaging portion of each positioning assembly is ∠-shaped, and comprises an engaging surface and a sliding surface.

5. The stair climbing aid as claimed in claim 1, wherein a induction member is fixed adjacent to each positioning portion, the control mechanism comprises two control circuits, two buttons, two electromagnets and two sensors, which are symmetrically disposed, the buttons are connected to the control circuits, respectively, one of the electromagnets is inserted with a driving rod, the sensors cooperate with the induction members of the slide rails to carry out sensing operation, the control circuits are connected to a power source and each is electrically connected to its corresponding electromagnet and sensor, and the driving rods are connected to the positioning assemblies.

6. The stair climbing aid as claimed in claim 1, wherein the control mechanism comprises two positioning seats, two couple shafts, two springs, two linking assemblies and two control handles, which are symmetrically disposed, the positioning seat is U-shaped and is provided with its corresponding couple shaft and spring of the control mechanism, the couple shaft is inserted into its corresponding positioning seat, the spring of the control mechanism is mounted on its corresponding couple shaft, one end of each couple shaft is provided with a blocking piece, the other end of each couple shaft is connected to the connecting member to control the engaging portion of each positioning assembly, each linking assembly is provided with an elastic member, an end of the elastic member is provided with a locking tongue, the control handle is fixed on one side of the assist member by a connecting shaft and located at a position adjacent to its corresponding couple shaft, an elastic piece is mounted on the connecting shaft, the connecting shaft is inserted into the other side of the assist member to connect to the linking assembly, the control handle controls the rotation of its corresponding linking assembly, and the locking tongue of each linking assembly is located corresponding to the blocking piece.

7. The stair climbing aid as claimed in claim 6, wherein the locking tongue of each linking assembly comprises a pushing surface and a sliding surface.
